(19) United States
(12) Patent Application Publication
(10) Pub. No.: US 2021/0271331 A1
(43) Pub. Date: Sep. 2, 2021

(54) AUTOMATIC TELESCOPIC FOLDING METHOD FOR KEYBOARD AND LIFTING KEY

(71) Applicant: Dongguan Mingjian Electronic Technology Co., Ltd., Guangdong (CN)

(72) Inventor: Jianping LI, Guangdong (CN)

(21) Appl. No.: 17/261,200

(22) PCT Filed: Dec. 11, 2019
(86) PCT No.: PCT/CN2019/000244

§ 371 Date: Jan. 19, 2021

(30) Foreign Application Priority Data
May 31, 2019 (CN) 201910469676.8

(51) Int. Cl. G06F 3/02; H01H 3/12; H01H 13/705

(52) U.S. Cl. CPC G06F 3/0221; H01H 2227/028; H01H 13/705; H01H 3/125

(57) ABSTRACT

The present invention discloses a lifting key and a telescopic folding method. When a cover or handle is closed, the key is in a compressed state, and when the cover or handle of a device is opened, the cover or handle releases a traction mechanism, and the key drives a movable board to move by its own elastic force; after the movable board is displaced, a locked state between the movable board and an X balance frame is released, the X balance frame is unfolded under the force of a reset mechanism, and the key returns to a normal height; by slowly closing the cover or handle, the traction mechanism pulls the movable board under the action of the cover or handle, and the movable board moves back to return to an initial position. At this moment, the movable board is engaged with the X balance frame to make the key in the compressed state. The automatic lifting key of the present application can automatically expand the key when the cover is opened, and automatically contract the key when the cover is closed, which occupies a smaller space when the cover is closed, so as to make the notebook or Bluetooth keyboard thinner and easier to carry.

### BACKGROUND OF THE INVENTION

The present invention relates to the field of keyboard keys, and specifically relates to an automatic telescopic folding method for a keyboard and lifting key.

Keyboard is an instruction and data input device used to operate a device to run, and also refers to a group of function keys arranged by a system to operate a machine or equipment. The existing notebooks are becoming thinner and lighter, and the requirements for key stroke distance of the keyboard are becoming more and more stringent. However, if the key stroke is too short, the tapping experience of use will be seriously affected, and it is also easy to cause mistouch. In order to ensure the tapping experience on the keys, the tapping stroke needs 2.5-4.5 cm generally, plus the thickness of the key and a PCB board, the thickness of a keyboard will exceed 4.5 cm, which makes the notebook thicker and unable to meet customers' increasing requirements for thin and portable notebooks. Of course, the thin and compact key is not only suitable for notebooks, but also useful in the field of portable Bluetooth keyboards and the like.

### BRIEF SUMMARY OF THE INVENTION

Regarding the above problems, the present invention aims to provide an automatic lifting key and an automatic telescopic folding method for a keyboard that can effectively reduce the space occupied by the keyboard during storage.

In order to achieve this technical purpose, the solution of the present invention is: an automatic lifting key, including an X balance frame, a reset mechanism, a key seat, and a key, the key is arranged above the key seat, and the key and the key seat are provided with an X balance frame and a reset mechanism therebetween.

Preferably, a horizontally movable board is further provided under the key seat, the movable board is provided with a snap, and the X balance frame is provided with a convex post, the snap being corresponding to the convex post; and

the movable board is further connected with a traction mechanism at one end.

Preferably, the snap is a hook-shaped structure with a triangular groove, a front segment of the convex post is an arc-shaped board structure for transition, and a tail segment of the convex post is a trapezoidal board structure, and when being compressed, the trapezoidal board structure is tightly fitted with the snap.

Preferably, a PCB board under the key seat is correspondingly provided with a sensing module, which is a membrane switch, a photoelectric switch, or a Hall switch.

Preferably, the reset mechanism is a spring or a silicone elastic member.

An automatic telescopic folding method for a keyboard comprises the steps as below:

Step 1: when a cover or handle is closed, a key is in a compressed state, and when the cover or handle of a device is opened, the cover or handle releases a traction mechanism, and the key drives a movable board to move by its own elastic force;

Step 2: after the movable board is displaced, a locked state between the movable board and an X balance frame is released, the X balance frame is unfolded under the force of a reset mechanism, and the key returns to a normal height;

Step 3: by slowly closing the cover or handle, the traction mechanism pulls the movable board under the action of the cover or handle, and the movable board moves back to return to an initial position; at this moment, the movable board is engaged with the X balance frame to make the key in the compressed state.

Preferably, in the Step 1, one traction mechanism can drive a plurality of movable boards to move.

Preferably, in the Step 1, the cover or handle can drive a plurality of traction mechanisms, and different traction mechanisms can be driven in accordance with different rotation angle positions.

The beneficial effect of the present invention is as below: the automatic lifting key of the present application can automatically expand the key when the cover is opened, and automatically contract the key when the cover is closed. When the cover is closed, the space height is smaller, which can make notebook or Bluetooth keyboards thinner and easier to carry, and maintain an excellent tapping sense during use; meanwhile, when the cover is opened, it is in line with the daily operation habit to automatically release the traction mechanism, which requires no additional operations; when the cover is closed, the tractions are performed in groups such that the force is applied more reasonably when closing the cover, the cover is closed in a smoother way, and the traction mechanism is not easily damaged.

### BRIEF DESCRIPTION OF THE DRAWINGS

FIG. 1 is an exploded view of the present invention;

FIG. 2 is a local schematic diagram of the open state of the cover of the present invention;

FIG. 3 is a local schematic diagram of the closed state of the cover of the present invention;

FIG. 4 is an exploded view of the X balance frame of the present invention;

FIG. 5 is a schematic diagram of the key seat of the present invention;

FIG. 6 is a schematic diagram of the movable board of the present invention.

### DETAILED DESCRIPTION OF THE INVENTION

The present invention will be further described in details with reference to the drawings and specific embodiments.

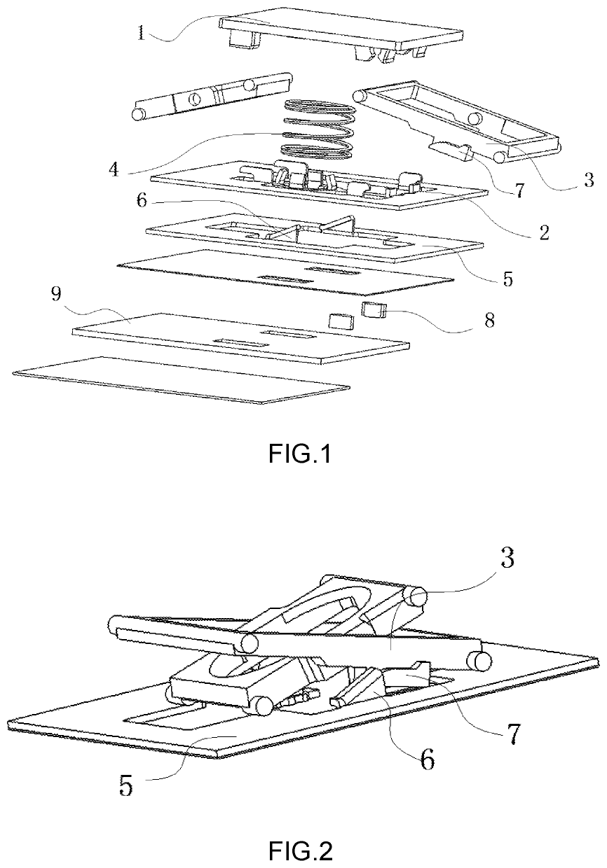

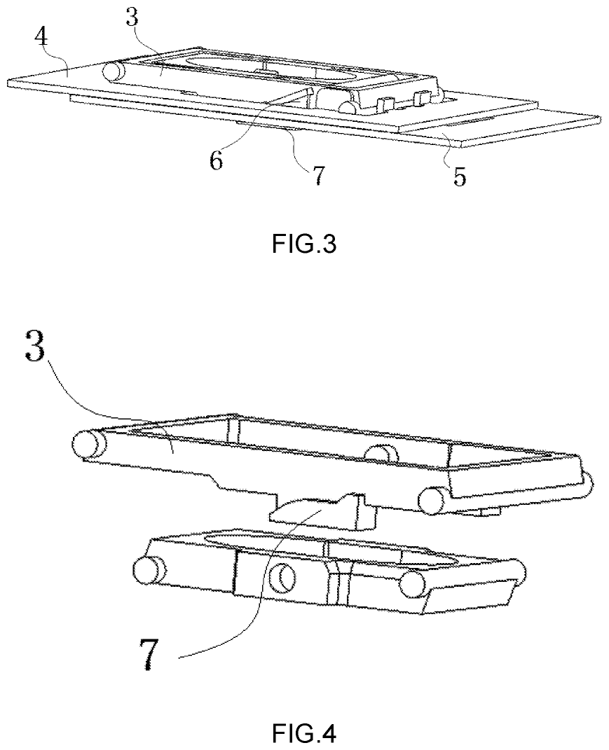

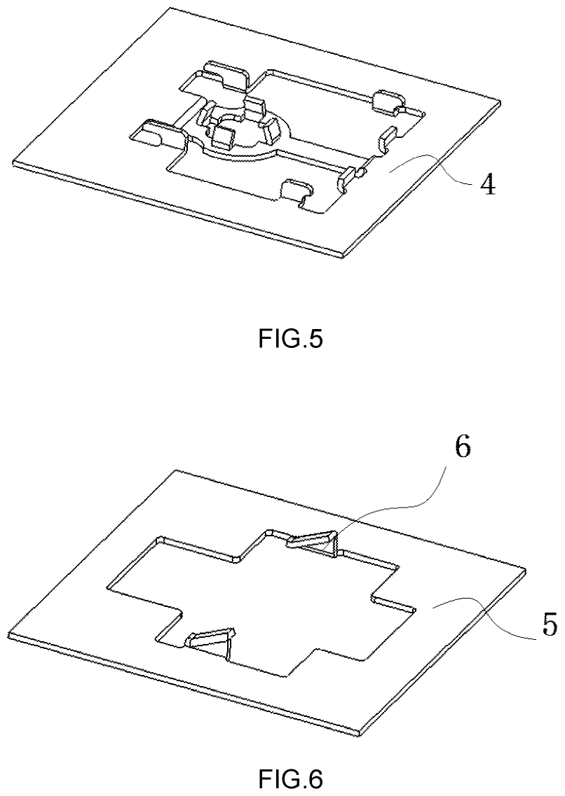

As shown in FIGS. 1-6, the specific embodiments of the present invention deal with an automatic telescopic folding method for a keyboard, comprising the steps as follows:

Step 1: when a cover or handle is closed, a key is in a compressed state, and when the cover or handle of a device is opened, the cover or handle releases a traction mechanism, and the key drives a movable board to move by its own elastic force;

Step 2: after the movable board is displaced, a locked state between the movable board and an X balance frame is released, the X balance frame is unfolded under the force of a reset mechanism, and the key returns to a normal height;

Step 3: by slowly closing the cover or handle, the traction mechanism pulls the movable board under the action of the cover or handle, and the movable board moves back to return to an initial position; at this moment, the movable board is engaged with the X balance frame to make the key in the compressed state.

In order to control changes in the telescopic state of multiple keys, in the Step 1, one traction mechanism can drive a plurality of movable boards to move. Since one keyboard has multiple keys, it is easier to operate that one traction mechanism drives multiple keys.

In order to make the telescopic process smoother, in the Step 1, the cover or handle can drive a plurality of traction mechanisms, and different traction mechanisms can be driven in accordance with different rotation angle positions. Generally, a pressing force of more than 45 grams is required to press a key, and a greater pressing force is required if pressing from the side. A keyboard generally has 66-104 keys, and if pressing them simultaneously, an overly great pressing force is required. Thus, the applicant believes that it is necessary to group the keys for traction, for example, when the cover or handle rotates for 0-15°, keys No. 1-20 are pulled, and when the cover or handle rotates for 15-30°, keys No. 21-40 are pulled, and so on. Accordingly, the closing action becomes smoother, and the traction mechanism is not easily damaged.

An automatic lifting key comprises: an X balance frame 3, a reset mechanism 2, a key seat 2, and a key 1, the key 1 is arranged above the key seat 2, and an X balance frame 3 and a reset mechanism 4 are arranged between the key 1 and the key seat 2, a horizontally movable board 5 is further provided under the key seat 2, the movable board 5 is provided with a snap 6, and the X balance frame 3 is provided with a convex post 7, the snap 5 being corresponding to the convex post 7: and the movable board 5 is further connected with a traction mechanism at one end.

In order to facilitate the key's automatic resetting, the reset mechanism 2 is a spring or a silicone elastic member.

In order to stably secure the X balance frame after the movable board shifts right horizontally or to loosen the X balance frame after the movable board shifts left horizontally, the snap 6 is a hook-shaped structure with a triangular groove, a front segment of the convex post 7 is an arc-shaped board structure for transition, a middle segment of the convex post 7 is a horizontal structure, and a tail segment of the convex post 7 is a trapezoidal board structure, and when being compressed, the trapezoidal board structure is tightly fitted with the snap. Because of the arc-shaped board structure, the snap can be transitioned smoothly. When the movable board shifts right to a designated position, the snap is engaged with the trapezoidal board structure, and meanwhile, the X balance frame also changes from an unfolded state to a compressed state.

The lifting key described herein is adaptive to a variety of sensing modules, suitable for membrane keyboards, photoelectric mechanical keyboards, and Hall switch keyboards. A PCB board 9 under the key seat 2 is correspondingly provided with a sensing module 8, which is a membrane switch, a photoelectric switch, or a Hall switch.

When in use, the cover is in the closed state, and the X balance frame is folded and contracted. At this time, the key takes up a smaller space height; when the cover is opened, the traction mechanism is released, the X balance frame automatically unfolds, and the key returns to a normal height. The present application can keep the notebook with the cover closed in a thinner state and make the key return to a normal state upon opening the cover by controlling the active state of the X balance frame of each key. The overall height of the compressed key may be less than 3.5 cm, which can save about 30% of the space height as compared to the existing notebook keyboards.

The automatic lifting key and method of the present application can automatically expand the key when the cover is opened, and automatically retract the key when the cover is closed. When the cover is closed, the space height is smaller, which can make notebook or Bluetooth keyboards thinner and easier to carry and maintain an excellent tapping sense during use; meanwhile, when the cover is opened, it is in line with the daily operation habit to automatically release the traction mechanism, which requires no additional operations; when the cover is closed, the tractions are performed in groups such that the force is applied more reasonably when closing the cover, the cover is closed in a smoother way, and the traction mechanism is not easily damaged.

The above as mentioned are only the preferred embodiments of the present invention, not intended to limit the present invention. Any minor modifications, equivalent replacements and improvements made to the above embodiments based on the technical essence of the present invention shall be included within the scope of protection of the technical solution of the present invention.

1: An automatic lifting key, comprising: an X balance frame, a reset mechanism, a key seat, and a key arranged above the key seat, the X balance frame and the reset mechanism being arranged between the key and the key seat;
a horizontally movable board is further provided under the key seat, the movable board is provided with a snap, and the X balance frame is provided with a convex post, the snap being corresponding to the convex post; and
the movable board is further connected with a traction mechanism at one end.

2. (canceled)

3: The automatic lifting key according to claim 1, characterized in that the snap is a hook-shaped structure with a triangular groove, a front segment of the convex post is an arc-shaped board structure for transition, and a tail segment of the convex post is a trapezoidal board structure, and when being compressed, the trapezoidal board structure is tightly fitted with the snap.

4: The automatic lifting key according to claim 1, characterized in that a PCB board under the key seat is correspondingly provided with a sensing module, which is a membrane switch, a photoelectric switch, or a Hall switch.

5: The automatic lifting key of claim 1, characterized in that the reset mechanism is a spring or a silicone elastic member.

6: An automatic telescopic folding method for a keyboard, comprising the steps as below:
Step 1: when a cover or handle is closed, a key is in a compressed state, and when the cover or handle of a device is opened, the cover or handle releases a traction mechanism, and the key drives a movable board to move by its own elastic force;
Step 2: after the movable board is displaced, a locked state between the movable board and an X balance frame is released, the X balance frame is unfolded under the force of a reset mechanism, and the key returns to a normal height;
Step 3: by slowly closing the cover or handle, the traction mechanism pulls the movable board under the action of the cover or handle, and the movable board moves back to return to an initial position; at this moment, the movable board is engaged with the X balance frame to make the key in the compressed state.

7: The automatic telescopic folding method for a keyboard according to claim 6, characterized in that, in the Step 1, one traction mechanism can drive a plurality of movable boards to move.

8: The automatic telescopic folding method for a keyboard according to claim 6, characterized in that, in the Step 1, the cover or handle can drive a plurality of traction mechanisms, and different traction mechanisms can be driven in accordance with different rotation angle positions.
